(19) United States
(12) Patent Application Publication
(10) Pub. No.: US 2024/0223010 A1
(43) Pub. Date: Jul. 4, 2024

(54) INDUCTIVE ENERGY-TRANSMITTING DEVICE FOR A LINEAR TRANSPORT SYSTEM

(71) Applicant: Beckhoff Automation GmbH, Verl (DE)

(72) Inventors: Jan Achterberg, Duisburg (DE); Andreas Brinker, Bakum (DE); Thomas Vorbohle, Rietberg (DE)

(21) Appl. No.: 18/603,703

(22) Filed: Mar. 13, 2024

Related U.S. Application Data
(63) Continuation of application No. PCT/EP2022/075673, filed on Sep. 15, 2022.

(30) Foreign Application Priority Data
Sep. 17, 2021 (DE) 10 2021 124 122.7

(51) Int. Cl. H02J 50/10; H01F 27/28

(52) U.S. Cl. CPC H02J 50/10; H01F 27/28

(57) ABSTRACT

An inductive energy-transmitting device is provided in a linear transport system in which at least one magnetically driven carriage moves along a carriage guide including a motor module device. The inductive energy-transmitting device includes an energy-transmitting coil having a primary winding for applying an input voltage and an energy-receiving coil having a secondary winding for tapping an output voltage. The secondary winding of the energy-receiving coil has a control-voltage-winding portion and a load-voltage-winding portion, the control-voltage-winding portion and the load-voltage-winding portion including winding conductor tracks separate from each other. In this context, the control-voltage-winding portion provides a control voltage for tapping by a carriage guide controller on the carriage, and the load-voltage-winding portion provides a load voltage for tapping by a load on the carriage

### CROSS-REFERENCE TO RELATED APPLICATIONS

This patent application is a continuation of International Patent Application No. PCT/EP2022/075673 filed Sep. 15, 2022, “Inductive Energy Transmission Device for a Linear Transport System,” which claims the priority of German patent application DE 10 2021 124 122.7 filed Sep. 17, 2021, “Induktive Energieübertragungseinrichtung für ein lineares Transportsystem,” each of which is incorporated by reference herein, in the entirety and for all purposes.

### FIELD

This application relates to an inductive energy-transmitting device for a linear transport system, a magnetically driven carriage having such an inductive energy-transmitting device, and a linear transport system.

### BACKGROUND

In linear transport systems, the carriage and rail guide form a linear motor. The rail guide is usually the stator of the linear motor and comprises drive coils. The carriages are the rotors of the linear motor and are provided with magnets. By energizing the drive coils in the rail guide, force is exerted upon the magnets of the carriages so that the carriages move along the rail guide.

The carriages may comprise tools and a carriage controller for exchanging data with a rail guide controller. In order to be able to operate such electrical consumers, which in the following are also referred to as loads, on the carriage without wires, a power transmission from the carriage guide to the carriage is required.

DE 10 2018 111 715 A1 describes a linear transport system having an inductive energy-transmitting device between a carriage guide and carriages that may travel on the carriage guide. The inductive energy-transmitting device comprises an energy-transmitting coil having a primary winding for applying an input voltage, the primary winding extending along the carriage guide. An energy-receiving coil of the inductive energy-transmitting device is arranged on each of the carriages and comprises a secondary winding for tapping an output voltage. The energy-transmitting coil and the energy-receiving coil are at least partially opposite each other when the carriage moves along the carriage guide to transmit energy from the energy-transmitting coil to the energy-receiving coil, which is then provided to an electrical load on the carriage. In the linear transport system of DE 10 2018 111 715 A1, in addition to inductive energy transmission, contactless data transmission between the carriage guide and the carriages is also provided with the aid of antennas arranged on the carriage guide and the carriages, respectively.

U.S. Pat. No. 10,483,895 B2 describes a further inductive energy-transmitting device for a linear transport system in which a primary winding of an energy-transmitting coil is arranged along a rail guide and each carriage comprises a secondary winding as an energy-receiving coil. The primary winding of the energy-transmitting coil and the secondary winding of the energy-receiving coil are each planar and arranged in such a way that, when the carriage is moved along the rail guide, the secondary winding is substantially aligned with the primary winding, leaving an air gap. The energy transmitted from the primary winding to the secondary winding is then provided to an electrical load located on the carriage.

### SUMMARY

The invention provides an inductive energy-transmitting device for a linear transport system in which the energy transmitted from the carriage guide to the carriages may be adjusted quickly and as required.

According to a first aspect, an inductive energy-transmitting device for a linear transport system, in which at least one magnetically driven carriage moves along a carriage guide comprising a motor module device, is provided. The inductive energy-transmitting device comprises an energy-transmitting coil having a primary winding for applying an input voltage, and an energy-receiving coil having a secondary winding for tapping an output voltage. The energy-transmitting coil is arranged on the motor module device and extends along the carriage guide. The energy-receiving coil is arranged at the carriage and extends along the carriage.

The energy-transmitting coil and the energy-receiving coil, when the at least one magnetically driven carriage moves along the carriage guide comprising the motor module device, at least partially oppose each other to transfer energy from the energy-transmitting coil to the energy-receiving coil. The secondary winding of the energy-receiving coil comprises a control-voltage-winding portion and a load-voltage-winding portion, the control-voltage-winding portion and the load-voltage-winding portion having separate winding conductor tracks from each other. The control-voltage-winding portion provides a control voltage for tapping by a carriage guide controller on the carriage. The load-voltage-winding portion provides a load voltage for tapping by a load on the carriage.

According to a second aspect, a magnetically driven carriage for a linear transport system comprises an energy-receiving coil having a secondary winding. The secondary winding of the energy-receiving coil comprises a control-voltage-winding portion and a load-voltage-winding portion, the control-voltage-winding portion and the load-voltage-winding portion having separate winding conductor tracks from each other. The control-voltage-winding portion provides a control voltage for tapping by a carriage guide controller on the carriage. The load-voltage-winding portion provides a load voltage for tapping by a load on the carriage.

According to a third aspect, a linear transport system comprises at least one magnetically driven carriage and a carriage guide comprising a motor module device. The at least one magnetically driven carriage moves along the carriage guide. The at least one magnetically driven carriage comprise an energy-receiving coil, the energy-receiving coil having a secondary winding for tapping an output voltage. The motor module device comprises a plurality of energy-transmitting coils, each energy-transmitting coil having a primary winding for applying an input voltage. The motor module device is arranged to select at least one energy-transmitting coil on the basis of control information and to adjust an energy transmission from the energy-transmitting coil to the energy-receiving coil on the carriage.

### EXAMPLES

In a linear transport system in which at least one magnetically driven carriage moves along a carriage guide having a motor module device, an inductive energy-transmitting device is provided which comprises an energy-transmitting coil having a primary winding for applying an input voltage and an energy-receiving coil having a secondary winding for tapping an output voltage. In this case, the energy-transmitting coil is arranged on the motor module device and extends along the carriage guide. The energy-receiving coil is arranged on the carriage and extends along the carriage.

The energy-transmitting coil and the energy-receiving coil at least partially face each other as the carriage moves along the carriage guide to transmit energy from the energy-transmitting coil to the energy-receiving coil. The secondary winding of the energy-receiving coil comprises a control-voltage-winding portion and a load-voltage-winding portion, wherein the control-voltage-winding portion and the load-voltage-winding portion comprise winding conductor tracks separate from each other. The control-voltage-winding portion provides a control voltage to be tapped by a carriage guide controller on the carriage, and the load-voltage-winding portion provides a load voltage to be tapped by a load on the carriage.

Dividing the secondary winding of the energy-receiving coil into a control-voltage-winding portion and a load-voltage-winding portion makes it possible to supply energy to different electrical loads on the carriage separately and as required, and in particular to ensure that the energy supply to the carriage controller always remains active and unaffected by the load voltage circuit for supplying carriage tools.

For example, the control-voltage-winding portion may supply a 24 V control voltage when idle and the load-voltage-winding portion may supply a 48 V load voltage when idle. The separate windings also make it possible to adjust the conductor cross-section and the number of windings for the load voltage in such a way that, for example, a significantly higher load voltage is generated for certain applications, while at the same time the control voltage remains unchanged. Furthermore, the load voltage may be changed very quickly separately from the control voltage and may also be switched off independently.

The cross-section of a winding conductor track forming the control-voltage-winding portion may be smaller than the cross-section of a winding conductor track forming the load-voltage-winding portion.

By dividing the secondary winding of the energy-receiving coil into two windings and the cross-sectional embodiment, the control-voltage-winding portion may provide a low power control voltage and the load-voltage-winding portion may provide a high power load voltage for a sensor system and/or an actuator system on the carriage.

The number of windings of the control-voltage-winding portion may be lower than the number of windings of the load-voltage-winding portion.

Due to the higher number of windings of the load-voltage-winding portion, a stable voltage may be achieved over a wider payload range.

The energy-transmitting coil and the energy-receiving coil may each comprise a coil body. The energy-transmitting coil body of the energy-transmitting coil and the energy-receiving coil body of the energy-receiving coil are aligned in parallel with regard to each other and are at least partially opposite to each other when the carriage moves along the carriage guide. The area spanned by the primary winding of the energy-transmitting coil is oriented in parallel with regard to the energy-transmitting coil body of the energy-transmitting coil. The surfaces spanned by the control-voltage-winding portion and the load-voltage-winding portion of the secondary winding of the energy-receiving coil are oriented perpendicular with regard to the energy-receiving coil body of the energy-receiving coil.

This embodiment provides a compact structure of the inductive energy-transmitting device with a flat energy-transmitting coil. The embodiment of the control-voltage-winding portion and of the load-voltage-winding portion perpendicular to the coil body of the energy-receiving coil allows for improved utilization of the winding space.

The energy-transmitting coil body of the energy-transmitting coil and the energy-receiving coil body of the energy-receiving coil may each be E-shaped in cross-section with two outer arm ribs and a central rib on a coil body area, wherein the E-shaped cross-sections face each other and the outer arm ribs and the central ribs of the coil body areas facing each other when the carriage moves along the carriage guide. The primary winding of the energy-transmitting coil is arranged between the first energy-transmitting coil outer arm rib and the second energy-transmitting coil outer arm rib of the energy-transmitting coil body around the energy-transmitting coil central ribs. The control-voltage-winding portion and the load-voltage-winding portion of the secondary winding of the energy-receiving coil are arranged between the first energy-receiving coil outer arm rib and the second energy-receiving coil outer arm rib of the energy-receiving coil body around the energy-receiving coil body area.

Compared with the primary winding of the energy-transmitting coil, which is embodied around the central rib of the coil body, twice the winding space for the control-voltage-winding portion and the load-voltage-winding portion of the secondary winding of the energy-receiving coil is provided, each of which is embodied around an outer arm rib of the coil body. The magnetic flux remains the same because the magnetic flux through a center rib of a coil body is higher than through an outer arm rib of a coil body. Due to the larger winding space, the number of windings of the windings may be increased for the same cross-section.

The energy-receiving coil body of the energy-receiving coil may comprise a first energy-receiving coil body portion and a second energy-receiving coil body portion, wherein the load-voltage-winding portion is embodied in the first energy-receiving coil body portion and the control-voltage-winding portion is embodied in the second energy-receiving coil body portion.

The division of the coil body of the energy-receiving coil, in which the control-voltage-winding portion and the load-voltage-winding portion are embodied as separate coil body portions, allows for a simplified coil structure and easier assembly.

The control-voltage-winding portion and the load-voltage-winding portion of the energy-receiving coil may also be nested.

The nested division of the control-voltage-winding portion and the load-voltage-winding portion of the energy-receiving coil at the coil body ensures that the magnetic flux in the coil body always remains symmetrical. As a result, load differences of the windings do not lead to asymmetries and dynamic changes in the magnetic flux through the coil body.

The energy-receiving coil may include a first energy-receiving coil circuit board comprising first winding conductor tracks, a second energy-receiving coil circuit board comprising second winding conductor tracks, and an energy-receiving coil body arranged between the first energy-receiving coil circuit board and the second energy-receiving coil circuit board. The first winding conductor tracks of the first energy-receiving coil circuit board and the second winding conductor tracks of the second energy-receiving coil circuit board are then connected to one another via electrical connectors to embody the control-voltage-winding portion and the load-voltage-winding portion of the secondary winding of the energy-receiving coil.

The printed circuit board embodiment of the energy-receiving coil, in which the winding conductor tracks are embodied on two separate printed circuit boards that are connected to each other via electrical connectors, simplifies the separate embodiment of the control-voltage-winding portion and load-voltage-winding portion of the secondary winding of the energy-receiving coil.

A cooling device for the control-voltage-winding portion and the load-voltage-winding portion of the secondary winding of the energy-receiving coil may be provided on the side of the energy-receiving coil winding portion facing away from the energy-transmitting coil winding portion of the energy-receiving coil.

In the winding arrangement of the energy-receiving coil, one winding side lies outside of the voltage transformer of the energy-transmitting device formed by the energy-transmitting coil and the energy-receiving coil and is thus suitable for attaching a cooling element. The cooling element may protrude from the carriage housing so that, for example, cooling fins of the cooling element are located outside of the carriage housing in order to be cooled by the travel wind of the carriage.

In a magnetically driven carriage for a linear transport system in which the carriage moves along a carriage guide having a motor module device, the control-voltage-winding portion of the secondary winding of the energy-receiving coil may be connected to a carriage controller via a first rectifier, and the load-voltage-winding portion of the secondary winding of the energy-receiving coil may be connected to a load via a second rectifier.

With this embodiment, a separate control voltage and load voltage circuit may be embodied on the magnetically driven carriage.

A load voltage circuit switch may be provided between the load-voltage-winding portion of the secondary winding of the energy-receiving coil and the load, which is connected to the carriage controller, wherein the carriage controller may open the load voltage circuit switch to disconnect the load from the load-voltage-winding portion.

The separate windings of the energy-receiving coil allow for a control voltage and a load voltage for the carriage to be generated as two independent voltages. A controller on the carriage, which is supplied by the control voltage, may then use the switch to monitor and influence the load voltage. For example, it is possible to disconnect the load voltage circuit from the load during load fluctuations, preventing an overvoltage from occurring on the load voltage circuit during a sudden drop in load, which may then cause damage to the electronics in the load voltage circuit. Energy may also be saved by shutting down the load voltage circuit, if necessary. The load voltage circuit control may be much faster locally on the carriage compared to an approach in which a current voltage value is first transmitted to the rail guide using a data transmission, and then the energy transmission of the energy-transmitting coil is adjusted by changing the frequency and/or amplitude.

A first energy storage device may be connected to the control-voltage-winding portion and a second energy storage device may be connected to the load-voltage-winding portion, the first energy storage device and the second energy storage device being configured to deliver temporarily stored electrical energy to the carriage controller and/or the load.

Improved energy storage may be achieved by tapping two separate voltages on the carriage. By selecting the first energy storage device or the second energy storage device, it is then possible to decide whether the control voltage should be buffered in an application in order to keep the controller active for longer in areas without energy transmission, or whether more power should be made available to the load voltage circuit for a short time at points with a high power requirement of the connected sensors or actuators. The two separate voltages also allow for a larger reserve to be achieved, for example for the control voltage to supply the control system on the carriage.

Furthermore, a linear transport system may be embodied with at least one magnetically driven carriage and a carriage guide having a motor module device, wherein the at least one magnetically driven carriage moves along the carriage guide. The motor module device comprises a plurality of energy-transmitting coils and is configured to select at least one energy-transmitting coil based on control information and to adjust an energy transmission from the energy-transmitting coil to the energy-receiving coil on the carriage.

It is thus possible to carry out a targeted and optimally adjusted energy transmission from the motor module device to the magnetically driven carriage.

### BRIEF DESCRIPTION OF THE DRAWINGS

The invention is described in more detail with reference to the accompanying figures:

FIG. 1 shows a curved portion of a linear transport system.

FIG. 2 shows the motor module with the guided carriage from the linear transport system of FIG. 1.

FIG. 3 shows a sectional view through the motor module with guided carriages from FIG. 2.

FIGS. 4A-4D show a first embodiment of an inductive energy-transmitting device.

FIGS. 5A-5D show a second embodiment of an inductive energy-transmitting device.

FIGS. 6A-6C show the first embodiment of FIGS. 4A-4D with a removed printed circuit board.

FIG. 7 shows an electrical circuit diagram of a primary side of an inductive energy-transmitting device.

FIG. 8 shows an electrical circuit diagram of a secondary side of an inductive energy-transmitting device.

FIG. 9 shows an electrical circuit diagram of a secondary side of an inductive energy-transmitting device with an energy storage.

In the figures, the same reference numerals are used for the same features. Furthermore, for reasons of clarity, it is provided that not all elements are always shown in every figure and that not every element is provided with its own reference numeral in every drawing.

### DETAILED DESCRIPTION

In a linear transport system, magnetically driven carriages are moved along a carriage guide comprising motor modules. The motor modules and the carriages form a linear motor, wherein the motor modules have electromagnetic coils, hereinafter also referred to as drive coils, and the carriages each carry magnets, for example in the form of magnet plates, which in combination with the drive coils of the motor modules generate a controlled propulsive force. The motor modules are further provided with power electronics and position detection for the carriages.

The carriage guide comprises guide rail elements for the carriages arranged on or next to the motor modules, which define the travel path of the carriages. The carriages each comprise a guide mechanism for movement on the guide rail. The carriage guide may be of any shape and, in particular, form a closed carriage travel path. The desired geometries, lengths and radii are determined by the number and/or selection of motor modules and the associated guide rail elements.

The carriages may be moved freely along the entire travel path specified by the carriage guide, i.e. the carriage may brake, accelerate, position and exert a constant force when stationary and in motion. The carriage movement may also be synchronized with other movement processes. With a closed carriage travel path, the carriages may be moved endlessly.

The carriages may be moved independently of one another. This means that the carriages may move to predefined positions along the entire travel path or may be moved relative to one another. The carriages may automatically accumulate to form a moving buffer from which a moving target may be approached with high dynamics. In the ongoing movement, groups of carriages may be formed that stop together or approach processing stations with a predefined speed profile.

There are basically no restrictions with regard to the number of carriages on the carriage guide. The number of carriages is determined by the length of the carriage guide and may be optimized for the desired application. For position detection by the motor modules, the carriages each comprise a position encoder that transmits a carriage position signal to the motor modules.

The linear transport system may be embodied as a double air gap linear motor. The magnets at the carriage then surround the drive coils of the motor modules on two opposite sides. The carriage thus absorbs the attractive forces of the magnets on both sides of the motor modules and largely compensates the attractive forces with respect to the guide mechanism on the carriage. The carriage guide mechanism may then run on the guide rail of the carriage guide with little wear.

The linear transport system is versatile and allows for a very fast material transport. Thus, products may be shifted, a product distance may be adjusted and/or a product speed may be reduced or increased by controlling the carriages accordingly. Products may also be clamped, moved, transported and discharged.

In addition, linear transport systems often also have the object of manipulating a product, i.e. lifting it, closing it, turning it, screwing a closure shut, etc. This may be carried out with the aid of processing stations on the carriage guide, but also by tools on the carriage. The carriage tool may e.g. be a gripper, a pusher, a drill or an alignment device.

However, in addition to a tool for product manipulation, a different type of electrical consumer, for example a measuring tool for measuring a physical quantity such as temperature, pressure, current, voltage, acceleration, mass, etc., may also be provided on the carriage.

Furthermore, a carriage controller may be provided on the carriage. The carriage controller may serve to exchange data with the controller of the rail guide containing the motor modules. The object of such a data exchange may be to transmit status information, for example measuring signals, which may then be taken into account in the context of controlling the carriage movement. However, the object of such a data exchange may also be to transmit control information for a carriage tool from the rail guide to the carriage. Furthermore, the carriage control may also be used to autonomously control the tool provided on the carriage.

In order to be able to operate the carriage tool or the carriage control, an energy supply is required for the carriage. A wireless design is achieved by inductive energy transmission to the carriage. A device for such an inductive energy transmission comprises at least one energy-transmitting coil, which comprises a primary winding extending along the carriage guide. Each carriage further comprises at least one energy-receiving coil having a secondary winding extending along the carriage. The energy-transmitting coil on the carriage guide and the energy-receiving coil on the carriage are arranged in such a way that when the energy-receiving coil of the carriage is in the region of the energy-transmitting coil of the carriage guide, the energy-receiving coil and the energy-transmitting coil at least partially overlap. The energy-transmitting coil then forms a voltage transformer with the energy-receiving coil.

The carriage guide control system detects a corresponding movement position of the carriage on the carriage guide using the positioning detection system and causes an input voltage to be applied to the energy-transmitting coil. The energy-receiving coil then picks up an output voltage which is made available to the electrical consumers on the carriage.

In order to provide a fast and demand-oriented energy supply, the secondary winding of the energy-transmitting coil comprises two winding portions, a control-voltage-winding portion and a load-voltage-winding portion, which have winding conductor tracks separate from each other. The energy-receiving coil then provides two separate voltages as an output voltage, a control voltage for tapping by the carriage controller and a load voltage for tapping by the load on the carriage.

The carriage control may thus be supplied with energy independently and, as a result, remain uninfluenced by the other electrical consumers on the carriage. The voltages for the carriage control and of the load may also be set independently of each other. The control voltage or the load voltage may be determined via the number of windings of the respective winding conductor tracks. For example, the load-voltage-winding portion may be embodied with a smaller conductor cross-section and a higher number of windings to provide a higher load voltage compared to the control voltage of the control-voltage-winding portion. For example, the control-voltage-winding portion may provide an open-circuit voltage of 24 V control voltage, whereas the load-voltage-winding portion provides a load voltage of 48 V during no-load operation.

In the following, embodiments of the inductive energy-transmitting device for a linear transport system, in which the secondary winding of the energy-transmitting coil comprises two winding conductor tracks separated from each other for a control-voltage-winding portion and a load-voltage-winding portion, are described.

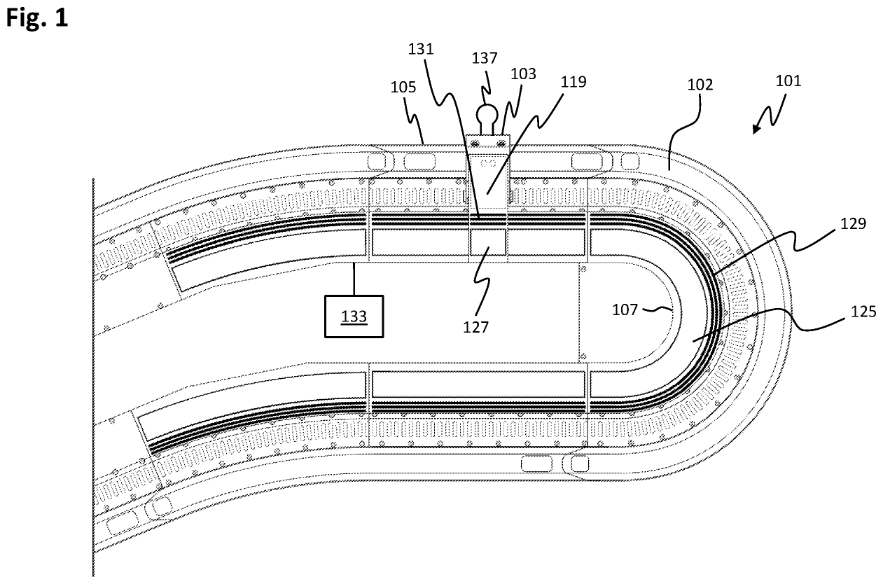

FIG. 1 shows a curved portion of a linear transport system 101 in a top view or as a lateral view, depending on how the linear transport system is oriented in space. As parts of a carriage guide 102 of the linear transport system 101, five motor modules 107 are shown in FIG. 1, on each of which a guide rail element 105 is mounted. The motor modules 107 have different configurations in some cases, with an arrangement of a curved motor module, a straight motor module, a 180-degree motor module, a straight motor module, and a curved motor module being shown. The guide rail elements 105 of the motor modules 107 are each adjusted to the shape of the motor module, i.e., curved, straight, or bent by 180 degrees. The carriage guide 102 of the linear transport system 101 forms a travel path, the path of which is located in a plane.

The linear transport system 101 comprises a carriage guide controller 133 connected to the motor modules 107 to control their operation. It may be provided, as shown in FIG. 1, that the carriage guide controller 133 is connected to only a single motor module 107, with the other motor modules 107 then being connected to the connected motor module 107 via a communication bus to allow for the exchange of signals between the carriage guide controller 133 and the various motor modules 107. However, the carriage guide controller may alternatively be connected to each or more motor modules. Furthermore, the carriage guide controller may also comprise a plurality of units arranged in a distributed manner.

Depending on the application, any number of carriages 103 may be provided on the carriage guide 102 of the linear transport system 101. On the portion of the carriage guide 102 shown in FIG. 1, a single carriage 103 is guided on the carriage guide 102.

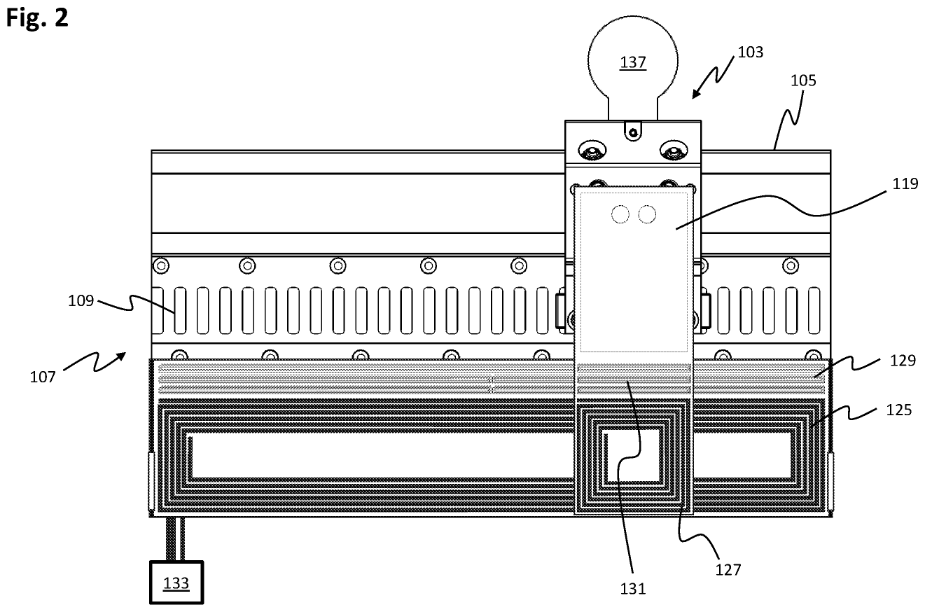

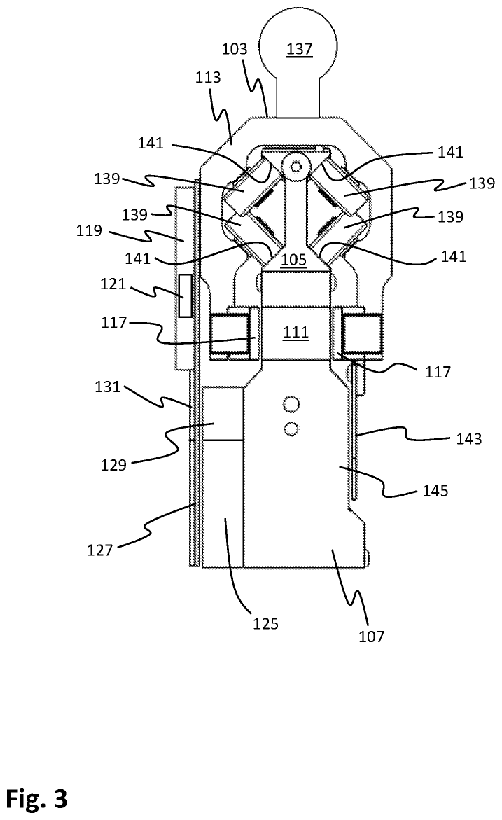

FIG. 2 shows the motor module 107 with the guide rail element 105 of FIG. 1, on which the single carriage 103 is guided. FIG. 3 shows a sectional view through the motor module 107 with the guide rail element 105 and the guided carriage 103 of FIG. 2.

The motor modules 107 of the carriage guide 102 and the carriages 103 moving on the carriage guide 102 form the linear motor of the linear transport system 101. The motor modules 107, as the stator of the linear motor, each include a plurality of pole teeth 109 spaced apart from each other along the motor module 107. The pole teeth 109 are substantially rod-shaped and oriented transversely with regard to the motor module 107. Each second pole tooth 109 is provided with a drive coil winding 111 shown in a sectional view in FIG. 3. The wound pole teeth 109 form the drive coils of the linear motor.

As shown in FIG. 3, the carriages 103 are substantially symmetrical with respect to a longitudinal center plane. A U-shaped carriage head 113 arranged on the guide rail element 105 comprises two legs, on the inner sides of each of which four track rollers 139 are provided as a guide mechanism for the carriage 103 on the guide rail element 105. Each roller 139 is assigned to an inner running surface 141 of the guide rail element 105, which is T-shaped in cross-section.

Magnet plates 117 are arranged on the inner sides of each of the two leg ends of the carriage head 113, and surround the drive coil winding 111 of the motor module 107. The magnet plates 117 and the drive coil winding 111 located in between form a double air gap linear motor. The attraction forces of the magnet plates 117 are compensated on both sides of the drive coil winding 111 of the motor module 107, so that the track rollers 139 of the carriage 103 roll on the track surfaces 141 of the guide rail element 105 causing little wear.

As shown in the cross-section of FIG. 3, a position element 143 in the form of an encoder flag having a metallic surface extends in parallel with regard to the motor modules 107 of the carriage guide 102 and is connected to one leg of the carriage head 113. In this case, the position element 143 at the carriage 103 is located on the side of the carriage opposite to the side of the carriage shown in the views of FIG. 1 and FIG. 2.

The same applies to the position sensor device 145 provided on the motor modules 107 of the carriage guide 102, which determines the position of the carriage 103 in interaction with the position element 143 at the carriage 103. The position sensor device 145, which is disposed in the motor module 107 opposite the position element 143 of the carriage 103, is at least one energized coil extending along the motor module 107, the current of which is varied by the position element 143 so as to detect the position of the position element 143 and thus the position of the carriage 103.

As an alternative to detecting the position of the carriage 103 using a stand-alone system consisting of the position element 143 at the carriage 103 and the position sensor device 145 in the motor modules 107 of the carriage guide 102, the position data of the carriage 103 may also be determined based on energizing the drive coil windings 111 of the motor modules 107. A further way to determine the position data is to use magnetic field sensors, such as 3D Hall sensors, arranged on the motor modules 107 of the carriage guide 102 to detect the magnet plates 117 on the carriage 103.

For data transmission between the carriage guide 102 and the carriage 103, the motor modules 107 comprise an antenna array 129 extending along the carriage guide 102, as shown in the side views of FIG. 1 and FIG. 2. A further carriage antenna 131 is provided on each carriage 103, which is located in an attachment 119 on the carriage head 113. As FIG. 3 shows, the attachment 119 is arranged opposite to the positioning element 143, which is embodied as an encoder flag with a metallic surface, on the other leg of the carriage head 113 and extends beyond the end of the leg in parallel to the motor modules 107 of the carriage guide 102. The carriage antenna 131 is in this context fixed in the carriage head attachment 119 in the region opposite to the antenna array 129.

The antenna array 129 and the carriage antenna 131 may be used to exchange data between the carriage guide 102 and the carriage 103. Alternatively, however, a data transmission may also take place via a wireless LAN, a Bluetooth, an infrared, a 5G connection, a DECT standard or an optical connection both directly between the carriage 103 and the carriage guide controller 133 of the motor modules 107 without the interposition of components of the carriage guide 102.

A data transmission from the carriage guide 102 to the carriage 103 of the linear transport system 101 is carried out in such a way that, at first, the position data of the carriage 103 are determined by the carriage guide controller 133 using the position sensor device 145 on the carriage guide 102 in cooperation with the position element 143 at the carriage 103. Subsequently, the carriage guide controller 133 selects the antenna from the antenna array 129 of the carriage guide 102 that faces the carriage 103 and thus the carriage antenna 131. Next, the carriage guide controller 133 outputs a data packet to the motor module 107 at which the selected antenna is located. The data packet includes a control signal identifying the selected antenna and a data signal to be transmitted by the selected antenna. The data signal includes a start sequence and payload data, wherein the start sequence is arranged to trigger data reception by the carriage 103. For receiving data, the carriage 103 includes a carriage controller 121 connected to the carriage antenna 131 and arranged in the carriage head attachment 119.

The data exchange between the carriage guide 102 and the carriage 103 is reciprocal. The carriage controller 121 may also transmit a data packet via the carriage antenna 131 to the antenna array 129 of the carriage guide 102, wherein the antenna from the antenna array 129, which is opposite to the carriage 103 and thus the carriage antenna 131, then receives the data packet and forwards it to the carriage guide controller 133.

A load 137 is further arranged on the carriage 103. The load 137 is shown in the figures in the form of a placeholder and may e.g. be embodied as an electric tool.

An inductive energy-transmitting device is provided to supply electrical power to the carriage controller 121 and the load 137. The inductive energy-transmitting device comprises an array of energy-transmitting coils 125 extending along the carriage guide 102 adjacent to the antenna array 129. As shown in the views of FIGS. 1 and 2, each motor module 107 comprises at least one energy-transmitting coil 125 associated therewith to provide continuous inductive energy transmission along the carriage guide 102. Instead of a closed array of energy-transmitting coils, only individual motor modules may comprise an energy-transmitting coil 125 to carry out point-to-point inductive energy transmission.

The inductive energy-transmitting device comprises an energy-receiving coil 127 on each carriage 103, which is located on the carriage head attachment 119 adjacent to the carriage antenna 131, as shown in the sectional view of FIG. 3. In this regard, the energy-receiving coil 127 is arranged on the carriage head attachment 119 so as to face the array of energy-transmitting coils 125 on the carriage guide 102, with the energy-receiving coil 127 at the carriage 103 covering the energy-transmitting coil 125 at the motor module 107. The area occupied by the energy-transmitting coil 125 at the motor module 107 is rectangular, whereas the energy-receiving coil 127 at the carriage 103 may be square. However, the energy-receiving coil 127 at the carriage 103 may also be rectangular in shape.

The size of the air gap between the energy-transmitting coil 125 and the energy-receiving coil 127 may also be used to determine the amount of energy transmitted. In order to be able to adjust the air gap as optimally as possible, also due to manufacturing tolerances, it may be advantageous to provide an adjustment option on the carriage 103, for example in the form of a screw, with which the distance between the carriage head attachment 119 and the carriage head 113 and thus the air gap may be set and readjusted.

The energy-transmitting coil 125 at the motor module 107 comprises a primary winding 126 having a continuous winding track. In contrast, a secondary winding 128 of the energy-receiving coil 127 at the carriage 103 is divided up into two winding portions, a control-voltage-winding portion 146 and a load-voltage-winding portion 147, which have separate winding conductor tracks.

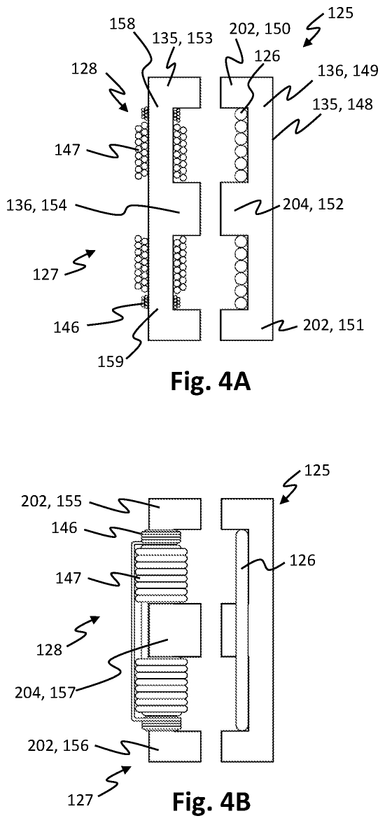

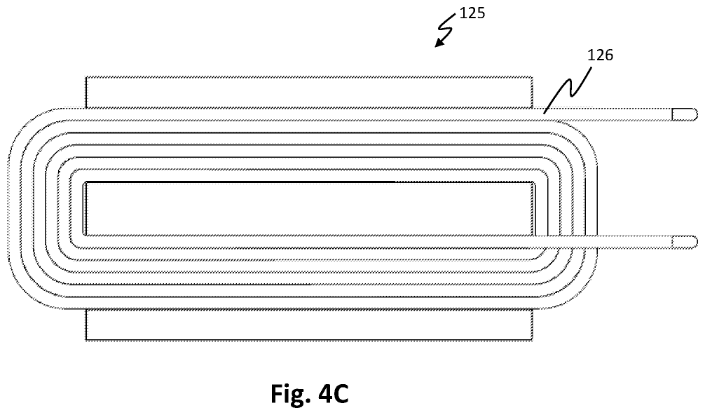

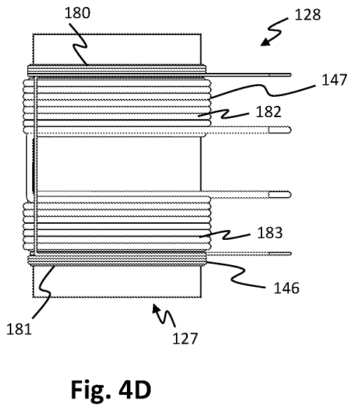

FIGS. 4A-4D show a first embodiment of the inductive energy-transmitting device in a highly schematic depiction. FIG. 4A shows a sectional view through the inductive energy-transmitting device, FIG. 4B shows a lateral view of the inductive energy-transmitting device, FIG. 4C shows a top view of the energy-transmitting coil 125 viewed from the perspective of the energy-receiving coil 127, and FIG. 4D shows a top view of the energy-receiving coil 127 viewed in the direction of the energy-transmitting coil 125.

The energy-transmitting coil 125 and the energy-receiving coil 127 each comprise a cross-sectionally E-shaped coil body 135, wherein the coil body may be an energy-transmitting coil body 148 and/or an energy-receiving coil body 153, comprising two outer arm ribs 202, wherein the outer arm rib may be referred to as the first energy-transmitting coil outer arm rib 150 and/or the second energy-transmitting coil outer arm rib 151 and or the first energy-receiving coil outer arm rib 155 and/or the second energy-receiving coil outer arm rib 156, and an intermediate center rib 204, wherein the center rib may be referred to as energy-transmitting coil center rib 152 and/or energy-receiving coil center rib 157 on a coil body area 136, wherein the coil body area may be referred to as energy-transmitting coil body area 149 and/or energy-receiving coil body area 154. The E-shaped cross-sections of the energy-transmitting coil body 148 of energy-transmitting coil 125 and the energy-receiving coil body 153 of energy-receiving coil 127 face each other, with the outer arm ribs 202 and the center rib n 204 on the coil body area 136 facing each other, and an air gap is formed between the coil bodies 135.

The coil body 135 are preferably made of ferromagnetic material and may be an iron body, a high-frequency iron body or a ferrite body. The ferromagnetic material of the coil body 135 provides high inductance. However, the coil bodies 135 may also be made of a non-ferromagnetic material to provide inductance independent of coil current.

As shown in the top view of FIG. 4C, the energy-transmitting coil 125 is embodied as a flat coil. The winding conductor track of a primary winding 126 of the energy-transmitting coil 125 is spirally wound around the energy-transmitting coil central rib 152 of the energy-transmitting coil body 148 and extends between the energy-transmitting coil central rib 152 and the first energy-transmitting coil outer arm rib 150 and second energy-transmitting coil outer arm rib 151, as shown in the sectional view of FIG. 4A and the lateral view of FIG. 4B. As shown in the top view of FIG. 4C, the two free ends of the winding conductor track are led laterally outward and serve as terminals for applying an electric voltage.

In the embodiment shown in FIGS. 4A-4D, the primary winding 126 comprises six conductor windings that are insulated from one another. However, it is possible to provide more or fewer windings depending on the inductance value to be achieved in the primary winding 126. Also, the coil windings may be multi-layered depending on the size of the coil body area 136.

A secondary winding 128 of the energy-receiving coil 127 is wound in such a way that the winding conductor track extends around the energy-receiving coil body area 154 between the first energy-receiving coil outer arm rib 155 and the second energy-receiving coil outer arm rib 156 and the energy-receiving coil center rib 157, as shown in the sectional view of FIG. 4A and the lateral view of FIG. 4B. Thus, the energy-receiving coil body area 154 spanned by the secondary winding 128 is oriented perpendicularly with regard to the energy-transmitting coil body area 154 spanned by the primary winding 126.

The winding conductor track of the secondary winding 128 of the energy-receiving coil 127 is divided up into a control-voltage-winding portion 146 and a load-voltage-winding portion 147. The control-voltage-winding portion 146 and the load-voltage-winding portion 147 are nested in the embodiment shown in FIGS. 4A-4D, the control-voltage-winding portion 146 and the load-voltage-winding portion 147 are each embodied symmetrically with respect to the energy-receiving coil center rib 157 of the energy-receiving coil body 153.

As shown in the sectional view of FIG. 4A and the lateral view of FIG. 4B, the control-voltage-winding portion 146 and the load-voltage-winding portion 147 each comprise a first control-voltage-winding portion winding sector 180 and a first load-voltage-winding portion winding sector 182 in a first energy-receiving coil body area portion 158 of the energy-receiving coil body area 154 extending between the first energy-receiving coil outer arm rib 155 and the energy-receiving coil central rib 157, and a second control-voltage-winding portion winding sector 181 and a second load-voltage-winding portion winding sector 183 in a second energy-receiving coil body area portion 159 of the energy-receiving coil body area 154 extending between the energy-receiving coil central rib 157 and the second energy-receiving coil outer arm rib 156.

The winding conductor tracks of the two winding sectors of the control-voltage-winding portion 146 and the load-voltage-winding portion 147 are each connected to one another via a conductor track arranged at the back of the coil surface, as shown in the side view of FIG. 4B. As shown in the top view of FIG. 4D, the interconnecting conductor tracks are formed on the side of the energy-receiving coil body 153. The two free ends of the winding conductor track of the control-voltage-winding portion 146 and the load-voltage-winding portion 147 each serve as terminals for tapping an electric voltage, and are embodied opposite to the connecting conductor tracks laterally outward at the energy-receiving coil body 153. In this regard, the winding sense of the two windings is additionally rotated in the respective winding sectors.

As shown in the sectional view of FIG. 4A and in the lateral view of FIG. 4B, the winding sectors of the control-voltage-winding portion 146 and the load-voltage-winding portion 147 are arranged in such a way that adjacent to the first energy-receiving coil outer arm rib 155, the first control-voltage-winding portion winding sector 180 of the control-voltage-winding portion is wound around the first energy-receiving coil body area portion 158 of the energy-receiving coil body area 154 of the energy-receiving coil 127. Subsequent thereto in the first energy-receiving coil body area portion 158 of the energy-receiving coil body area 154 of the energy-receiving coil 127 is the first load-voltage-winding portion winding sector 182 of the load-voltage-winding portion 147, which extends to the energy-receiving coil central rib 157.

The second winding sectors of the control-voltage-winding portion 146 and the power voltage winding portion 147 are embodied in a symmetrical manner with regard thereto. The second load-voltage-winding portion winding sector 183 of the load-voltage-winding portion 147 is wound adjacent to the energy-receiving coil central rib 157 around the second energy-receiving coil body area portion 159 of the energy-receiving coil body area 154 of the energy-receiving coil 127. Then, in the remaining portion of the second energy-receiving coil body area portion 159 of the energy-receiving coil body area 154 of the energy-receiving coil 127 to the second energy-receiving coil outer arm rib 156, the second control-voltage-winding portion winding sector 181 of the control-voltage-winding portion 146 extends.

The connecting conductor track between the first load-voltage-winding portion winding sector 182 and the second load-voltage-winding portion winding sector 183 of the load-voltage-winding portion 147 is in this context guided adjacently with regard to the energy-transmitting coil body 148 and along the energy-receiving coil central rib 157. The connecting conductor track between the first control-voltage-winding portion winding sector 180 and the second control-voltage-winding portion winding sector 181 of the control-voltage-winding portion 146 extends across the winding sectors of the load-voltage-winding portion 147.

The nested configuration of the control-voltage-winding portion 146 and the load-voltage-winding portion 147 of the energy-receiving coil 127 ensures that a symmetrical magnetic flux exists in the energy-receiving coil body 153. By arranging the control-voltage-winding portion 146 and the load-voltage-winding portion 147 perpendicularly with regard to the energy-receiving coil body 153 of the energy-receiving coil 127, improved utilization of the winding space is achieved. Compared to the planar winding embodiment around the energy-transmitting coil central rib 153 of the energy-transmitting coil body 148, the perpendicular winding design of the energy-receiving coil 127 results in a double winding space. However, the magnetic flux remains the same because the magnetic flux through the center rib of the coil body is higher than through the first and second outer ribs of the coil body. Due to the larger winding space, the number of windings of the windings may be increased for the same cross-section, which leads to an increased inductance.

By dividing up the secondary winding 128 of the energy-receiving coil 127 into the control-voltage-winding portion 146 and the load-voltage-winding portion 147, the energy supply to the carriage controller 121 and the energy supply to the load 137 may be optimized in a separate manner. The number of windings may be used to set a desired voltage in each case. For example, the control-voltage-winding portion 146 may supply a 24 V control voltage when idle and the load-voltage-winding portion 147 may supply a 48 V load voltage when idle. The control-voltage-winding portion 146 then has a lower number of windings than the load-voltage-winding portion 147. In the embodiment shown in FIGS. 4A-4D, the control-voltage-winding portion 146 comprises seven windings and the load-voltage-winding portion 147 comprises sixteen windings, each having two winding layers. However, depending on the coil body size, more or fewer winding layers may be provided.

By dividing up the secondary winding 128 of the energy-receiving coil 127 into a control-voltage-winding portion 146 and a load-voltage-winding portion 147, it is also possible to adjust the cross-sections of the winding conductor tracks to the respective power requirements of the connected electrical loads, i.e. the carriage controller 121 and the load 137 provided on the carriage. Since the power requirement of the carriage controller 121 is generally lower than the power requirement of sensors or actuators on the carriage 103, the cross-section of the winding conductor track of the control-voltage-winding portion 146 is made smaller than the cross-section of the winding conductor track of the load-voltage-winding portion 147, as shown in the embodiment of FIGS. 4A-4D.

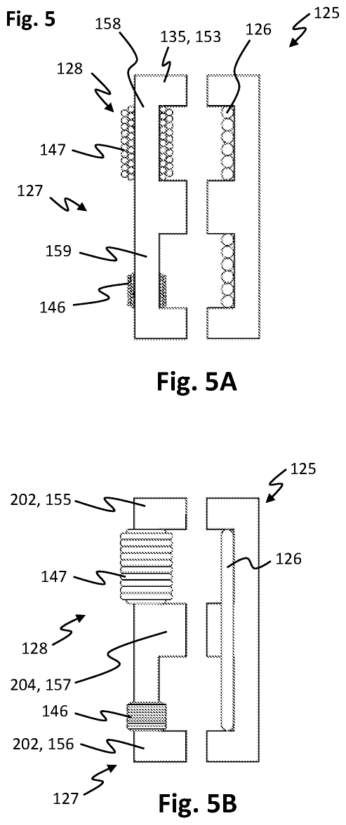

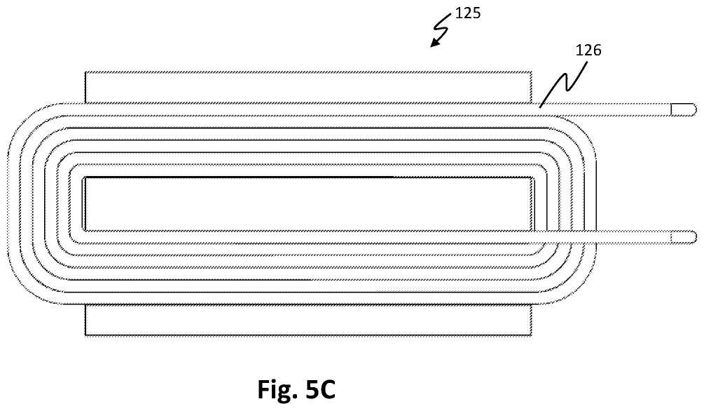

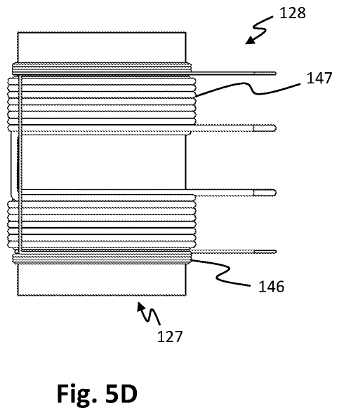

FIGS. 5A-5D show a second embodiment of the inductive energy-transmitting device in a highly schematized depiction. FIG. 5A shows a sectional view through the inductive energy-transmitting device, FIG. 5B shows a lateral view of the inductive energy-transmitting device, FIG. 5C shows a top view of the energy-transmitting coil 125 viewed from the perspective of the energy-receiving coil 127, and FIG. 5D shows a top view of the energy-receiving coil 127 viewed in the direction of the energy-transmitting coil 125.

The structure of the second embodiment of the inductive energy-transmitting device in FIGS. 5A-5D is essentially the same as the structure of the first embodiment of the inductive energy-transmitting device in FIG. 4A-4D. The energy-receiving coils 127 of the first and second embodiments of the inductive energy-transmitting device have identical structures. The difference between the first and second embodiments is the configuration of the secondary winding 128 of the energy-receiving coil 127.

Instead of a nested arrangement of the control-voltage-winding portion 146 and the load-voltage-winding portion 147 of the energy-receiving coil 127 of the first embodiment as shown in FIGS. 4A-4D, in the second embodiment shown in FIGS. 5A-5D, the control-voltage-winding portion 146 and the load-voltage-winding portion 147 are implemented spatially separated from each other.

As FIGS. 5A-5D show, the load-voltage-winding portion 147 is wound around the first energy-receiving coil portion 158 of the energy-receiving coil body area 154 between the first energy-receiving coil outer arm rib 155 and the energy-receiving coil central rib 157, whereas the control-voltage-winding portion 146 is wound around the second energy-receiving coil body area portion 159 of the energy-receiving coil body area 154 between the energy-receiving coil central rib 157 and the second energy-receiving coil outer arm rib 156. In this case, the load-voltage-winding portion 147, which is embodied with a larger winding conductor track cross-section, covers the entire portion area. The control-voltage-winding portion 146, which is embodied with a smaller winding conductor track cross-section and has fewer windings, extends adjacent to the second energy-receiving coil outer arm rib 156 over only a portion of the second energy-receiving coil body area portion 159 of the energy-receiving coil body area 154.

By separately arranging the control-voltage-winding portion 146 and the load-voltage-winding portion 147 of the energy-receiving coil 127, it is not necessary to provide connecting conductor tracks for the winding sectors across the energy-receiving coil central rib 157 of the energy-receiving coil body 153, as implemented in the embodiment shown in FIGS. 4A-4D, allowing for a simplified structure.

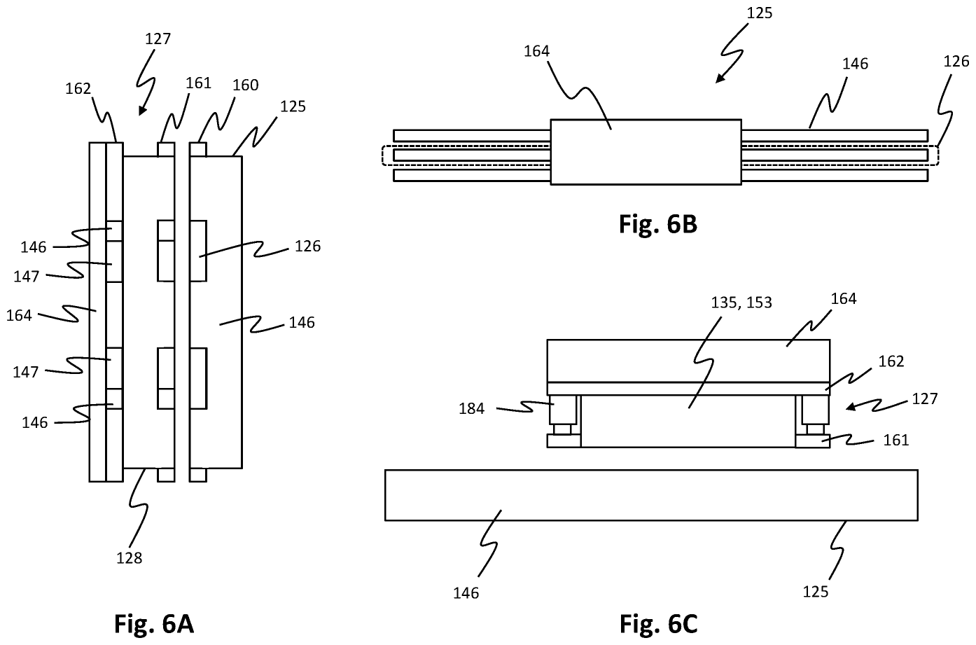

FIGS. 6A-6C show a highly schematic depiction of the first embodiment of the inductive energy-transmitting device from FIGS. 4A-4D in a variant in which the energy-transmitting coil 125 and the energy-receiving coil 127 are each embodied as board coils. Furthermore, in the variant, a cooling device 164 is additionally provided on the energy-receiving coil 127. FIG. 6A shows a sectional view through the inductive energy-transmitting device. FIG. 6B shows a top view of the inductive energy-transmitting device. FIG. 6C shows a bottom view of the inductive energy-transmitting device.

In the board coil embodiment, printed conductor tracks are provided on a printed circuit board of electrically insulated material instead of winding conductor tracks. The energy-transmitting coil 125, which is embodied as a flat coil, is embodied in such a way that the conductor tracks are printed spirally on an energy-transmitting coil printed circuit board 160. In addition, recesses are provided in the energy-transmitting coil circuit board 160 into which the energy-transmitting coil body 148, which is E-shaped in cross-section, engages, the printed conductor tracks being located between the central rib and the first and second outer arm ribs of the coil body.

The energy-receiving coil 127 comprises a first energy-receiving coil circuit board 161 and a second energy-receiving coil circuit board 162. On the first energy-receiving coil circuit board 161, first conductor track portions of the control-voltage-winding portion 146 and first conductor track portions of the load-voltage-winding portion 147 are printed, and on the second energy-receiving coil circuit board 162, second conductor track portions of the control-voltage-winding portion 146 and second conductor track portions of the load-voltage-winding portion 147 are printed.

The view in FIG. 6C then further shows, that the first track portions of the control-voltage-winding portion 146 are printed on the first energy-receiving coil circuit board 161 and the second track portions of the control-voltage-winding portion 146 are printed on the second energy-receiving coil circuit board 162, respectively, and the first track portions of the load-voltage-winding portion 147 are printed on the first energy-receiving coil circuit board 162. winding portion 147 on the first energy-receiving coil circuit board 161 and the second conductor track portions of the load-voltage-winding portion 147 on the second energy-receiving coil circuit board 162 are respectively connected to each other via electrical connectors 184, to embody a closed control-voltage-winding portion 146 and a closed load-voltage-winding portion 147 of the secondary winding 128 of the energy-receiving coil 127, respectively.

As shown in the sectional view of FIG. 6A, recesses are provided in the first energy-receiving coil circuit board 161 of the energy-receiving coil 127 for the cross-sectionally E-shaped energy-receiving coil body 153, which is arranged between the first energy-receiving coil circuit board 161 and the second energy-receiving coil circuit board 162 in engagement with the recesses of the first energy-receiving coil circuit board 161.

On the side of the energy-receiving coil 127 facing away from the energy-transmitting coil 125, the cooling device 164 for the secondary winding 128 of the energy-receiving coil 127 is arranged. The arrangement of the cooling device 164 on the secondary winding 128 is possible because, due to the vertical embodiment of the secondary winding 128, one winding side is located outside of the voltage transformer formed by the energy-transmitting coil 125 and the energy-receiving coil 127 and is thus accessible. The cooling device 164 may then be embodied in such a way that the cooling device 164 projects outwardly from the carriage head attachment 119 and may be cooled by the airstream of the carriage 103. Cooling fins as cooling elements are then particularly suitable for this purpose.

The variant of the first embodiment of the inductive energy-transmitting device of FIGS. 4A-4D shown in FIGS. 6A-6C, in which the energy-transmitting coil 125 and the energy-receiving coil 127 are each embodied as printed circuit board coils, may also be used in the second embodiment of the inductive energy-transmitting device shown in FIGS. 5A-5D. Furthermore, the cooling device 164 may also be provided with winding conductor tracks instead of printed conductor tracks in the embodiments shown in FIGS. 4A-4D and FIGS. 5A-5D. In turn, the embodiment shown in FIGS. 6A-6C may then also be implemented without a cooling device 164 on the energy-receiving coil 127. Furthermore, it is also possible to embody the inductive energy-transmitting device with a board coil and a wound coil as the energy-transmitting coil and energy-receiving coil, respectively.

Energy is transferred from the carriage guide 102, which has the motor module device, to the carriages 103 in the following manner: As the carriage 103 moves, the position data of the carriage 103 is determined in a continuous manner. The carriage guide controller 133 then selects the motor module 107 in which the energy-receiving coil 127 of the carriage 103 is opposite to the energy-transmitting coil 125 of the motor module 107. A plurality of motor modules 107 may be selected at the same time, as well, especially if the energy-receiving coil 127 of the carriage 103 overlaps with the energy-transmitting coils 125 of adjacent motor modules 107. The carriage guide controller 133 further determines the amount of energy to be transmitted by the energy-transmitting coil 125 of the selected motor module 107. The energy-transmitting coil 125 of the inductive energy transmission unit is then appropriately applied with an AC voltage or an AC current, respectively, to provide the amount of energy to be transferred.

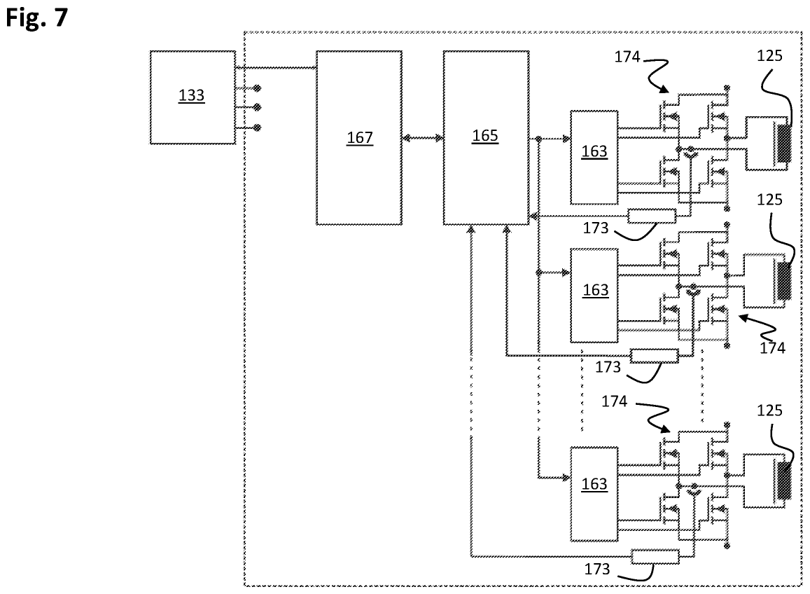

FIG. 7 shows an electrical circuit diagram of the carriage guide 102 for driving the energy-transmitting coils 125. Each energy-transmitting coil 125 is connected to an energy-transmitting coil switch 174, which in the embodiment shown in FIG. 7 is an H-bridge. The energy-transmitting coil switch 174 is operated with the aid of an upstream energy-transmitting coil driver 163, which in turn is controlled by an energy-transmitting coil microcontroller 165. In this regard, the energy-transmitting coil microcontroller 165 may drive the energy-transmitting coil drivers 163 of all motor modules 107, as shown in FIG. 7.

It is also possible to provide a separate microcontroller for each energy transmitter coil driver 163 or for groups of drivers, in particular of a motor module. The energy transmitter coil microcontroller 165 is connected to the carriage guide controller 133 via an energy transmitter coil communication interface 167. For power control, the energy-transmitting coil switch 174 is further provided with an energy-transmitting coil current meter 173 connected to the energy-transmitting coil microcontroller 165 to provide feedback to the energy-transmitting coil microcontroller 165 on the amount of energy delivered by the associated energy-transmitting coil 125.

The voltage applied to the primary winding 126 of the energy-transmitting coil 125 changes the magnetic flux in the energy-receiving coil 127, which in turn results in an AC voltage in the control-voltage-winding portion 146 or the load-voltage-winding portion 147 of the secondary winding 128 of the energy-receiving coil 127. By appropriately embodying the control-voltage-winding portion 146 and the load-voltage-winding portion 147, respectively, an open-circuit voltage of 24 V may be obtained in the control-voltage-winding portion 146 and an open-circuit voltage of 48 V may be obtained in the load-voltage-winding portion 147, for example. The desired voltage values may be set via the number of windings of the winding portions or the respective conductor track cross-section.

The control-voltage-winding portion 146 and the load-voltage-winding portion 147 are each connected to rectifiers. Furthermore, a capacitor may be additionally provided for smoothing in the control voltage circuit and the load voltage circuit, respectively. The carriage controller 121 may also be used to monitor and influence the load voltage. A switch is then arranged in the load voltage circuit in order to be able to disconnect the load 137 from the load-voltage-winding portion 147, as the case may be. In this context, the switch may be operated by the carriage controller 121. Thus, in the event of load fluctuations in the load voltage circuit, the carriage controller 121 may disconnect the connection between the load-voltage-winding portion 147 and the load 137 with the aid of the switch to e.g. prevent an overvoltage from occurring in the load voltage circuit in the event of a sudden drop in the load, which may cause destruction of the electronics in the load voltage circuit. The disconnection of the load voltage circuit may also be used to save energy, if necessary.

Direct controlling of the load voltage circuit on the carriage 103 by the carriage controller 121 may be much faster compared to an approach in which the voltage value is set by the carriage guide controller 133, which first requires transfer of the voltage values from the carriage 103 to the carriage guide controller 133.

An energy storage device may also be additionally provided in each of the control voltage circuit and the load voltage circuit to temporarily store energy that may then be supplied to the carriage controller 121 and/or the load 137, if necessary. By having the control-voltage-winding portion 146 and the load-voltage-winding portion 147 provide two separate voltages on the carriage 103, improved energy storage may be achieved. It may then be decided whether to buffer the control voltage or the load voltage according to demand after selecting the respective energy storage device in the control voltage circuit or the load voltage circuit, respectively.

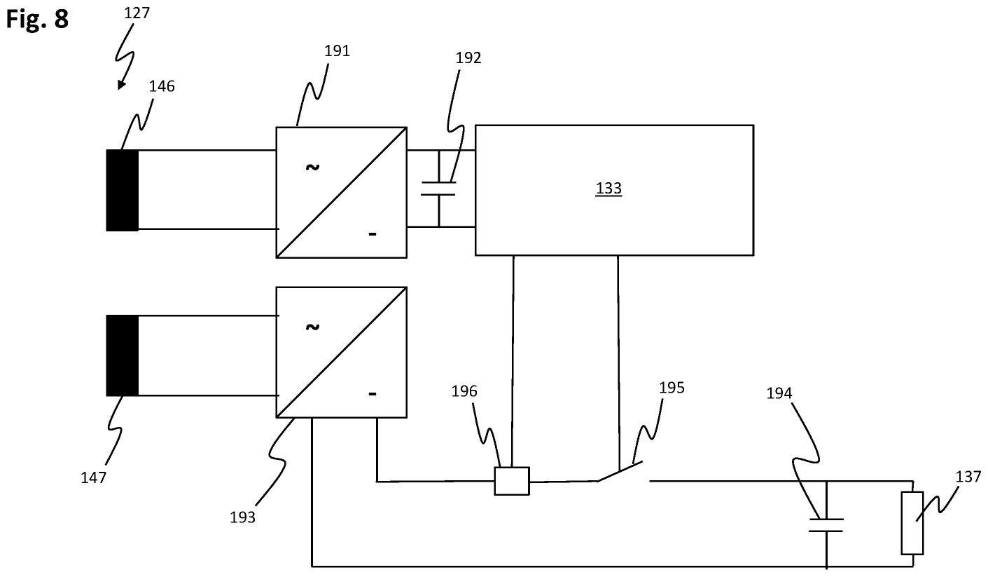

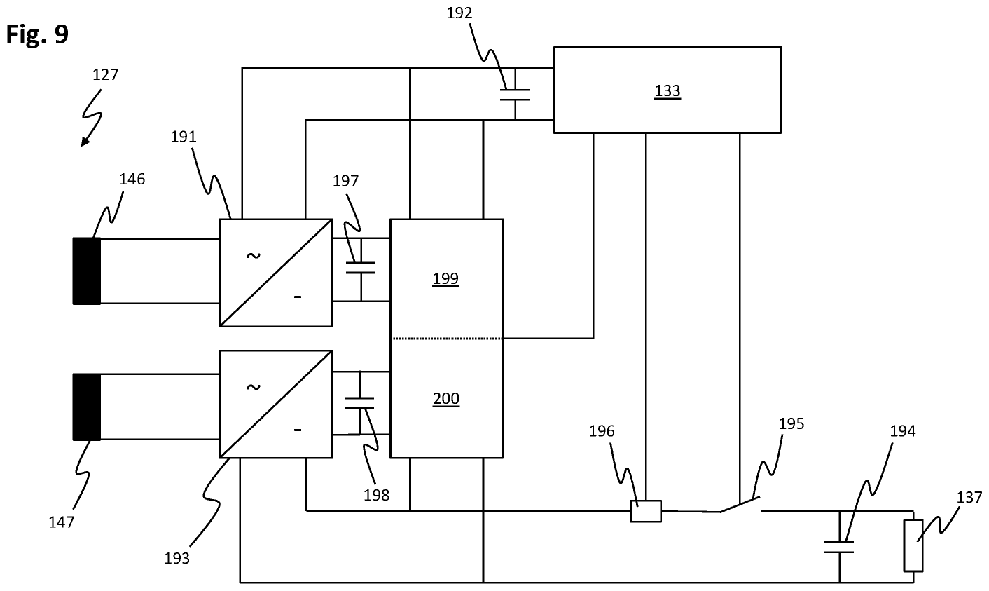

FIG. 8 and FIG. 9 show circuit diagrams for the control voltage circuit and the load voltage circuit on the carriage 103, with additional energy storage devices being provided in the embodiment shown in FIG. 9.

As FIG. 8 shows, the control-voltage-winding portion 146 is connected to a first rectifier 191, which in turn is connected to the carriage guide controller 133 via an intermediate first smoothing capacitor 192. The load-voltage-winding portion 147 is connected to a second rectifier 193. The second rectifier 193 is connected to the load 137 via a load voltage circuit switch 195 and an intermediate second smoothing capacitor 194. The load voltage circuit switch 195 is in turn connected to the carriage guide controller 133 and may be opened or closed by the carriage guide controller 133.

A load voltage circuit current meter 196 is further provided in the load voltage circuit between the second rectifier 193 and the load 137, the load voltage circuit current meter 196 being connected to the carriage guide controller 133 and providing feedback to the carriage guide controller 133 about the current value in the load voltage circuit.

FIG. 9 shows an extension of the circuit of FIG. 8 with additional energy storages. In parallel to the control voltage circuit, the control-voltage-winding portion 146 is connected to a first energy storage device 199 via a third smoothing capacitor 197. The first energy storage device 199 is then further connected to the control voltage circuit.

Furthermore, a second energy storage device 200 is provided, connected in parallel to the load voltage circuit and connected to the load-voltage-winding portion 147 via a fourth smoothing capacitor 198. The second energy storage device 200 is then further connected to the load voltage circuit.

The first energy storage unit 199 and the second energy storage unit 200 are controlled by the carriage guide controller 133. The carriage guide controller 133 may thus buffer the control voltage in the first energy storage 199 and the load voltage in the second energy storage 200 depending on the demand in the control voltage circuit. The buffered energy may then be fed back into the control voltage circuit or the load voltage circuit by the carriage guide controller 133, if necessary.

As shown in the embodiment shown in FIG. 9, the first energy storage unit 199 and the second energy storage unit 200 may form a common energy storage unit in order to provide the buffered energy to the carriage controller and/or the sensors or actuators connected in the load voltage circuit as required and depending on the carriage application.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
List of reference numerals: 1-149

| | |
|---|---|
| 101 | linear transport system |
| 102 | carriage guide |
| 103 | carriage |
| 105 | guide rail element |
| 107 | motor module |
| 109 | pole tooth |
| 111 | drive coil winding |
| 113 | carriage head |
| 117 | magnet plate |
| 119 | carriage head attachment |
| 121 | carriage controller |
| 125 | energy-transmitting coil |
| 126 | primary winding |
| 127 | energy-receiving coil |
| 128 | secondary winding |
| 129 | antenna array |
| 131 | carriage antenna |
| 133 | carriage guide controller |
| 135 | coil body |
| 136 | coil body area |
| 137 | load |
| 139 | roller |
| 141 | running surface |
| 143 | position element |
| 145 | position sensor device |
| 146 | control-voltage-winding portion |
| 147 | load-voltage-winding portion |
| 148 | energy-transmitting coil body |
| 149 | energy-transmitting coil body area |

TABLE 2
List of reference numerals: 150-204

| | |
|---|---|
| 150 | first energy-transmitting coil outer arm rib |
| 151 | second energy-transmitting coil outer arm rib |
| 152 | energy-transmitting coil-central rib |
| 153 | energy-receiving coil body |
| 154 | energy-receiving coil body area |
| 155 | first energy-receiving coil outer arm rib |
| 156 | second energy-receiving coil outer arm rib |
| 157 | energy-receiving coil central rib |
| 158 | first energy-receiving coil body area portion |
| 159 | second energy-receiving coil body area portion |
| 160 | energy-transmitting coil printed circuit board |
| 161 | first energy-receiving coil circuit board |
| 162 | second energy-receiving coil circuit board |
| 163 | energy transmitter coil driver |
| 164 | cooling device |
| 165 | energy-transmitting coil microcontroller |
| 167 | energy-transmitting coil communication interface |
| 173 | energy-transmitting coil-current meter |
| 174 | energy-transmitting coil switch |
| 180 | first control-voltage-winding portion winding sector |
| 181 | second control-voltage-winding portion winding sector |
| 182 | first load-voltage-winding portion winding sector |
| 183 | second load-voltage-winding portion winding sector |
| 184 | connector |
| 191 | first rectifier |
| 192 | first smoothing capacitor |
| 193 | second rectifier |
| 194 | second smoothing capacitor |
| 195 | load-voltage-circuit switch |
| 196 | load-voltage-circuit current meter |
| 197 | third smoothing capacitor |
| 198 | fourth smoothing capacitor |
| 199 | first energy storage |
| 200 | second energy storage |
| 202 | external arm rib |
| 204 | central rib |

What is claimed is:

1. An inductive energy-transmitting device for a linear transport system, in which at least one magnetically driven carriage moves along a carriage guide comprising a motor module device,
wherein the inductive energy-transmitting device comprises an energy-transmitting coil having a primary winding for applying an input voltage, and
an energy-receiving coil having a secondary winding for tapping an output voltage;
wherein the energy-transmitting coil is arranged on the motor module device and extends along the carriage guide,
wherein the energy-receiving coil is arranged at the carriage and extends along the carriage,
wherein the energy-transmitting coil and the energy-receiving coil, when the at least one magnetically driven carriage moves along the carriage guide comprising the motor module device, at least partially oppose each other to transfer energy from the energy-transmitting coil to the energy-receiving coil,
wherein the secondary winding of the energy-receiving coil comprises a control-voltage-winding portion and a load-voltage-winding portion, the control-voltage-winding portion and the load-voltage-winding portion having separate winding conductor tracks from each other, and
wherein the control-voltage-winding portion provides a control voltage for tapping by a carriage guide controller on the carriage, and
wherein the load-voltage-winding portion provides a load voltage for tapping by a load on the carriage.

2. The inductive energy-transmitting device according to claim 1, wherein the cross-section of the winding conductor track forming the control-voltage-winding portion is embodied to be smaller than the cross-section of the winding conductor track forming the load-voltage-winding portion.

3. The inductive energy-transmitting device according to claim 1, wherein the number of windings of the control-voltage-winding portion is lower than the number of windings of the load-voltage-winding portion.

4. The inductive energy-transmitting device according to claim 1,
wherein the energy-transmitting coil and the energy-receiving coil each comprise a coil body,
wherein the energy-transmitting coil body of the energy-transmitting coil and the energy-receiving coil body of the energy-receiving coil are aligned in parallel with regard to each other and at least partially face each other when the at least one magnetically driven carriage moves along the carriage guide comprising the motor module device,
wherein the area spanned by the primary winding of the energy-transmitting coil is oriented in parallel to the energy-transmitting coil body of the energy-transmitting coil, and
wherein the surfaces spanned by the control-voltage-winding portion and the load-voltage-winding portion of the secondary winding of the energy-receiving coil are oriented perpendicularly with regard to the energy-receiving coil body of the energy-receiving coil.

5. The inductive energy-transmitting device of claim 4,
wherein the energy-transmitting coil body of the energy-transmitting coil and the energy-receiving coil body of the energy-receiving coil are each E-shaped in cross-section with two outer arm ribs and a center rib on a coil body surface,
wherein the E-shaped cross-sections face each other and the outer arm ribs and the central ribs on the coil body surface face each other when the at least one magnetically driven carriage moves along the carriage guide comprising the motor module device, and
wherein the primary winding of the energy-transmitting coil is arranged between the first energy-transmitting coil outer arm rib and the second energy-transmitting coil outer arm rib of the energy-transmitting coil body around the energy-transmitting coil central rib, and wherein the control-voltage-winding portion and the load-voltage-winding portion of the secondary winding of the energy-receiving coil are arranged between the first energy-receiving coil outer arm rib and the second energy-receiving coil outer arm rib of the energy-receiving coil body around the energy-receiving coil body area.

6. The inductive energy-transmitting device according to claim 4,
wherein the energy-receiving coil body of the energy-receiving coil comprises a first energy-receiving coil body area portion and a second energy-receiving coil body area portion, and
wherein the load-voltage-winding portion is embodied in the first energy-receiving coil body area portion and the control-voltage-winding portion is embodied in the second energy-receiving coil body area portion.

7. The inductive energy-transmitting device according to claim 4, wherein the control-voltage-winding portion and the load-voltage-winding portion of the energy-receiving coil are nested.

8. The inductive energy-transmitting device according to claim 4,
wherein the energy-receiving coil includes a first energy-receiving coil circuit board comprising first winding conductor tracks, a second energy-receiving coil circuit board comprising second winding conductor tracks, and the energy-transmitting coil body arranged between said first energy-receiving coil circuit board and said second energy-receiving coil circuit board, and
wherein the first winding conductor tracks of the first energy-receiving coil circuit board and the second winding conductor tracks of the second energy-receiving coil circuit board are connected via electrical connectors to embody the control-voltage-winding portion and the load-voltage-winding portion of the secondary winding of the energy-receiving coil.

9. The inductive energy-transmitting device according to claim 4, wherein a cooling device for the control-voltage-winding portion and the load-voltage-winding portion of the secondary winding of the energy-receiving coil is provided on the side of the energy-receiving coil body of the energy-receiving coil facing away from the energy-transmitting coil body of the energy-transmitting coil.

10. A magnetically driven carriage for a linear transport system, comprising:
an energy-receiving coil having a secondary winding,
wherein the secondary winding of the energy-receiving coil comprises a control-voltage-winding portion and a load-voltage-winding portion, the control-voltage-winding portion and the load-voltage-winding portion having separate winding conductor tracks from each other,
wherein the control-voltage-winding portion provides a control voltage for tapping by a carriage guide controller on the carriage, and
wherein the load-voltage-winding portion provides a load voltage for tapping by a load on the carriage.

11. The magnetically driven carriage according to claim 10,
wherein the control-voltage-winding portion of the secondary winding of the energy-receiving coil is connected to a carriage guide controller via a first rectifier, and
wherein the load-voltage-winding portion of the secondary winding of the energy-receiving coil is connected to a load via a second rectifier.

12. The magnetically driven carriage according to claim 10,
wherein a load voltage circuit switch is provided between the load-voltage-winding portion of the secondary winding of the energy-receiving coil and a load, the load voltage circuit switch being connected to the carriage guide controller, and
wherein the carriage guide controller may open the load voltage circuit switch to disconnect the load from the load-voltage-winding portion.

13. The magnetically driven carriage according to claim 10,
wherein a first energy storage is connected to the control-voltage-winding portion and a second energy storage is connected to the load-voltage-winding portion, and
wherein the first energy storage and the second energy storage are set up to output the temporarily stored electrical energy to the carriage guide controller and/or the load.

14. A linear transport system comprising:
at least one magnetically driven carriage, and
a carriage guide comprising a motor module device;
wherein the at least one magnetically driven carriage moves along the carriage guide,
wherein the at least one magnetically driven carriage comprise an energy-receiving coil, the energy-receiving coil having a secondary winding for tapping an output voltage,
wherein the motor module device comprises a plurality of energy-transmitting coils, each energy-transmitting coil having a primary winding for applying an input voltage, and
wherein the motor module device is arranged to select at least one energy-transmitting coil on the basis of control information and to adjust an energy transmission from the energy-transmitting coil to the energy-receiving coil on the carriage.

15. The linear transport system according to claim 14,
wherein the secondary winding of the energy-receiving coil of the at least one magnetically driven carriage comprises a control-voltage-winding portion and a load-voltage-winding portion, the control-voltage-winding portion and the load-voltage-winding portion having separate winding conductor tracks from each other,
wherein the control-voltage-winding portion provides a control voltage for tapping by a carriage guide controller on the carriage, and
wherein the load-voltage-winding portion provides a load voltage for tapping by a load on the carriage.

16. The linear transport system according to claim 15, wherein the cross-section of the winding conductor track forming the control-voltage-winding portion is embodied to be smaller than the cross-section of the winding conductor track forming the load-voltage-winding portion.

17. The linear transport system according to claim 15,
wherein the control-voltage-winding portion of the secondary winding of the energy-receiving coil is connected to a carriage guide controller via a first rectifier, and
wherein the load-voltage-winding portion of the secondary winding of the energy-receiving coil is connected to a load via a second rectifier.

18. The linear transport system according to claim 15,
wherein a load voltage circuit switch is provided between the load-voltage-winding portion of the secondary winding of the energy-receiving coil and a load, the load voltage circuit switch being connected to the carriage guide controller, wherein the carriage guide controller may open the load voltage circuit switch to disconnect the load from the load-voltage-winding portion.

19. The linear transport system according to claim 15,
wherein a first energy storage is connected to the control-voltage-winding portion and a second energy storage is connected to the load-voltage-winding portion, and
wherein the first energy storage and the second energy storage are set up to output the temporarily stored electrical energy to the carriage guide controller and/or the load.
